(19) United States
(12) Patent Application Publication
(10) Pub. No.: US 2013/0059281 A1
(43) Pub. Date: Mar. 7, 2013

(54) SYSTEM AND METHOD FOR PROVIDING REAL-TIME GUIDANCE TO A USER

(71) Applicant: Fenil Shah, Barrington, RI (US)

(72) Inventor: Fenil Shah, Barrington, RI (US)

(21) Appl. No.: 13/604,791

(22) Filed: Sep. 6, 2012

Related U.S. Application Data
(60) Provisional application No. 61/531,291, filed on Sep. 6, 2011.
(60) Provisional application No. 61/675,362, filed on Jul. 25, 2012.

(51) Int. Cl. G09B 5/00

(52) U.S. Cl. 434/308

(57) ABSTRACT

A method, system and product of providing real-time guidance to a user for performing an activity through a portable computing device. The portable computing device has at least one camera and at least one display. The method includes displaying an instructional video of an activity on a display, the instructional video comprising one or more instructions for performing the activity. Then capturing a real-time video of the user using a camera of a portable computing device, and then displaying the real-time video of the user on the display, wherein the real-time video and the instructional video are displayed simultaneously on the display, the simultaneous display of the real-time video and the instructional video enable the user to perform the activity.

### CROSS-REFERENCE TO RELATED APPLICATION

This application is an U.S. non-provisional utility application under 35 U.S.C. §111(a) based upon co-pending U.S. provisional applications 61/531,291 filed on Sep. 6, 2011 and 61/675,362 filed on Jul. 25, 2012. Additionally, this U.S. non-provisional utility application claims the benefit of priority of co-pending U.S. provisional applications 61/531,291 filed on Sep. 6, 2011 and 61/675,362 filed on Jul. 25, 2012. The entire disclosure of the prior applications is incorporated herein by reference.

### BACKGROUND OF THE INVENTION

1. Field of the Invention

The invention relates to remote guidance. More specifically, the present invention relates to providing real-time guidance to a user through a portable computing device.

2. Description of the Prior Art

With the advent of new technologies in the field of education and training, a user need not require to be present in the same geographical location as of the instructor to learn or acquire a skill/activity. There are various methods, such as web-conferences, online instructional videos etc. through which the user can remotely take trainings.

However, learning through online videos is not very useful as by the time the user tries to implement the technique by replicating instructor in the video, the instructor in the video moves forward to the next technique. Due to this the previous steps are either forgotten or not performed in a proper manner. Further, there is no provision of direct one-on-one feedback or evaluation for the learner's actions in a pre-recorded video environment. The existing solution also does not provide the user the flexibility to be mobile and learn at any place.

In light of the above, there is a need for a solution that enables users to learn practical skills in a mobile environment.

While the above-described devices fulfill their respective, particular objectives and requirements, the aforementioned patents do not describe a system and method for providing real-time guidance to a user that allows for the performing of an activity by the user.

Therefore, a need exists for a new and improved system and method for providing real-time guidance to a user that can be used for performing of an activity by the user. In this regard, the present invention substantially fulfills this need. In this respect, the system and method for providing real-time guidance to a user according to the present invention substantially departs from the conventional concepts and designs of the prior art, and in doing so provides an apparatus primarily developed for the purpose of performing of an activity by the user.

### SUMMARY OF THE INVENTION

In view of the foregoing disadvantages inherent in the known types of online videos now present in the prior art, the present invention provides an improved system and method for providing real-time guidance to a user, and overcomes the above-mentioned disadvantages and drawbacks of the prior art. As such, the general purpose of the present invention, which will be described subsequently in greater detail, is to provide a new and improved system and method for providing real-time guidance to a user which has all the advantages of the prior art mentioned heretofore and many novel features that result in a system and method for providing real-time guidance to a user which is not anticipated, rendered obvious, suggested, or even implied by the prior art, either alone or in any combination thereof.

Various embodiments of the present invention provide a method of providing real-time guidance to a user through a portable computing device, the real-time guidance enabling a user to perform an activity. The portable computing device includes a camera. The method includes displaying an instructional video of the activity on a display. The instructional video includes one or more instructions for performing the activity. The device allows capturing a real-time video of the user using the camera. The real-time video of the user or the activity being performed is displayed on the display, wherein the real-time video and the instructional video are displayed simultaneously on the display. The simultaneous display of the real-time video and the instructional video enable the user to perform the activity.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved system and method for providing real-time guidance to a user that has all of the advantages of the prior art online videos and none of the disadvantages.

It is another object of the present invention to provide a new and improved system and method for providing real-time guidance to a user that may be easily and efficiently manufactured and marketed.

Still another object of the present invention is to provide a new system and method for providing real-time guidance to a user that provides in the apparatuses and methods of the prior art some of the advantages thereof, while simultaneously overcoming some of the disadvantages normally associated therewith.

Even still another object of the present invention is to provide a system and method for providing real-time guidance to a user for providing real-time guidance to a user through a portable computing device. This allows device allows capturing a real-time video of the user using the camera. The real-time video of the user or the activity being performed is displayed on the display, wherein the real-time video and the instructional video are displayed simultaneously on the display. The simultaneous display of the real-time video and the instructional video enable the user to perform the activity.

Lastly, it is an object of the present invention to provide a new and improved method of providing real-time guidance to a user for performing an activity through a portable computing device having a camera. The method includes displaying an instructional video of the activity on a display, the instructional video comprising one or more instructions for performing the activity. Then capturing a real-time video of the user using the camera. Afterwards, displaying the real-time video of the user on the display, wherein the real-time video and the instructional video are displayed simultaneously on the display, the simultaneous display of the real-time video and the instructional video enable the user to perform the activity.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. The features of the present invention, which are believed to be novel, are set forth with particularity in the appended claims. Embodiments of the present invention will hereinafter be described in conjunction with the appended drawings provided to illustrate and not to limit the scope of the claims, wherein like designations denote like elements, and in which:

FIG. 1 is a block diagram illustrating a portable computing device for providing real-time guidance to a user, in accordance with various embodiments of the present invention;

FIG. 2 is a block diagram illustrating a system for providing real-time guidance to a user for performing an activity, in accordance with various embodiments of the present invention;

FIG. 3 is a block diagram illustrating a display simultaneously displaying a real-time video and an instructional video, in accordance with an embodiment of the present invention;

FIG. 4 is a flowchart illustrating a method for providing real-time guidance to a user for performing an activity, in accordance with an embodiment of the present invention;

FIG. 5 is a block diagram illustrating a system for providing real-time guidance to a user for performing an activity, in accordance with another embodiment of the present invention;

FIG. 6 is a block diagram illustrating a display simultaneously displaying an instructional video and at least one real-time video, in accordance with another embodiment of the present invention;

FIG. 7 is a block diagram illustrating a multi-user environment for collaborative learning of an activity, in accordance with an embodiment of the present invention;

FIG. 8 is a block diagram illustrating a system for providing real-time guidance to a user for performing an activity, in accordance with yet another embodiment of the present invention;

FIG. 9 is a block diagram illustrating a display simultaneously displaying a real-time video and an instructional video, in accordance with yet another embodiment of the present invention;

FIG. 10 is a flowchart illustrating a method for providing real-time guidance to a user for performing an activity, in accordance with another embodiment of the present invention;

FIG. 11 is a block diagram illustrating a mesh network formed inside the portable computing device, in accordance with an embodiment of the present invention; and

FIG. 12 is a flowchart illustrating a method for providing real-time guidance to a user for performing an activity, in accordance with yet another embodiment of the present invention.

The same reference numerals refer to the same parts throughout the various figures.

### DETAILED DESCRIPTION OF THE INVENTION

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

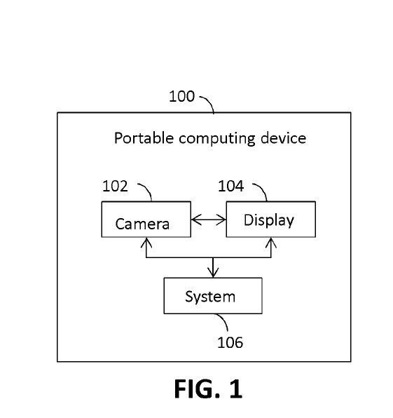

FIG. 1 illustrates a portable computing device 100 of a user for providing real-time guidance on an activity in accordance with various embodiments of the present invention. The portable computing device 100 is a user device that facilitates a user to perform and learn various instructional activities through pre-recorded/live instructional videos.

Examples of portable computing device 100 include, but are not limited to, smartphone, tablet, laptop, wearable computing devices, surface computing devices, devices with projection displays and hybrid devices. In an embodiment of the present invention, the portable computing device 100 is a handheld device, such as a smartphone or a tablet. The smartphones/tablets are lightweight, powerful and feature-rich devices providing tremendous flexibility and mobility to a user to be able to carry and use these devices to learn activities in any and all kinds of indoor and outdoor environments. Their features such as advanced touch based screens, powerful multimedia capabilities, built in video cameras, accelerometers, gyroscopes, and voice recognition abilities, etc. enable users to ease learning of a wide range of activities.

The portable computing device 100 includes a camera 102, a display 104, and a system 106. The camera 102 is configured to capture a real-time video of a user. In an embodiment of the present invention, the camera 102 is a front camera of the portable computing device 100. In another embodiment, the camera 102 is a back camera of the portable computing device 100. In yet another embodiment, the camera 102 includes the front and back video camera. In yet another embodiment, the camera 102 is a web-camera.

The display 104 is a graphical user interface of the portable computing device 100. The system 106 is an educational tool configured to provide real-time guidance on an activity through the portable computing device 100. In one embodiment, the system 106 is a software application. In another embodiment, the system 106 is hardware. In yet another embodiment, the system 106 is a combination of hardware and software.

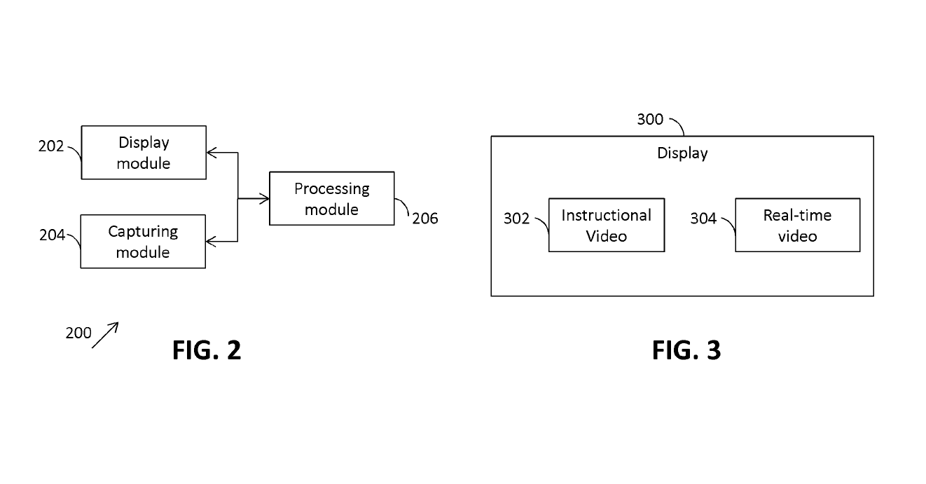

Referring now to FIG. 2, a system 200 for providing real-time guidance to a user on an activity, in accordance with an embodiment of the present invention, is shown. The system 200 comprises a display module 202, a capturing module 204, and a processing module 206.

Referring to FIG. 3, a block diagram of a display 300 in accordance with an embodiment of the present invention, is shown. The display 300 comprises an instructional video 302 and the real-time video 304. The instructional video 302 comprises a set of instructions for performing an activity.

The real-time video 304 comprises a user performing the activity according to the instructions described in the instructional video 302.

In one embodiment, the system 200 and the display 300 are present in the portable computing device 100.

In another embodiment, the system 200 is present in the portable computing device 100 and the display 300 is external to the portable computing device 100.

In various embodiments of the present invention, modules of the system 200 may be present in at least one of the portable computing device and a remote computing device.

In various embodiments, the camera 102, the system 200 and the display 300 are interconnected and may operate in unison to provide real-time guidance to a user for performing the activity.

The display module 202 is configured to display an instructional video 302 of an activity on the display 300. The instructional video 302 comprises a set of instructions for performing the activity. In one embodiment of the present invention, the instructional video 302 is a pre-recorded video stored in a memory of the portable computing device 100. In another embodiment, the instructional video 302 is a live video streamed by a remote computing device, such as a web server, when the portable computing device 100 is connected to the Internet.

In one embodiment, the instructional video 302 comprises instructional text for enabling a user to perform an activity. In another embodiment, the instructional video 302 comprises an instructor performing the activity in various steps. The user may learn the activity by performing the activity described in the instructional video 302. The activity may be paused after every step so as to ensure that a user does not skip any of the steps and gets sufficient time to practice each step along with the instructional video. At each step, the instructional video may include tags such as common mistakes, tips, more information, in the instructional video. Further, for each tag, the user may add additional media such as text, image and video.

In various embodiments of the present invention, the instructional videos may be related to, but not limited to, medical education, medical training procedures, physical therapy demonstrations, physical therapy exercises, dance postures and steps, martial arts steps, equipment handling, continuing adult and professional education, patient education and professional training courses.

The display module 202 is also configured to simultaneously display a plurality of videos on the display 300. For example, the display module 202 is configured to simultaneously display an instructional video 302 of an activity and a real-time video 304 of the user performing the activity on the display 300.

The capturing module 204 is configured to capture a real-time video 304 of the user using a camera 102 of the portable computing device 100. The capturing module 204 may be configured to start capturing a real-time video 304 of the user as soon as the user starts performing the activity illustrated in the instructional video 302. In an exemplary embodiment, the instructional video 302 comprises an instructor explaining the procedure of brushing of teeth. The user may watch the instructional video 302, and start brushing the teeth in a manner similar to the instructor. The capturing module 204 captures the real-time video 304 of the user brushing their teeth using a front camera.

The processing module 206 is configured to process the real-time video 304 of the user and an instructional video 302 of the activity for simultaneous display on the display 300. In a preferred embodiment, the instructional video 302 and the real-time video 304 are displayed side by side. However, side by side display should not be construed as limiting the scope of the invention as the instructional video 302 and the real-time video 304 can be placed on the display 300 in numerous other ways.

The simultaneous display of the instructional video 302 and the real-time video 304 enable a user to see their actions vis-a-vis the instructional video 302. The user gets an immediate visual feedback on their actions from their real-time video 304 on the display 300. Thus, the user can improvise their actions based on mismatch in the instructional video 302 and the real-time video 304. This enables the user to learn the activity described in the instructional video 302.

In an embodiment of the present invention, the portable computing device 100 includes a projection means for displaying the instructor video and the user video on a separate display. In another embodiment of the present invention, the portable computing device 100 is a wearable device that is wearable on the body of the user. Examples of wearable device include but not limited to wrist band, wrist watch, eye glasses, head display, necklace, pendant and the like.

In one embodiment of the present invention, the display module 202, the capturing module 204, and the processing module 206 may be implemented in hardware. In another embodiment, the modules 202-206 may be implemented in software. In another embodiment, the modules 202-206 may be implemented in a combination of hardware, software or a firmware thereof.

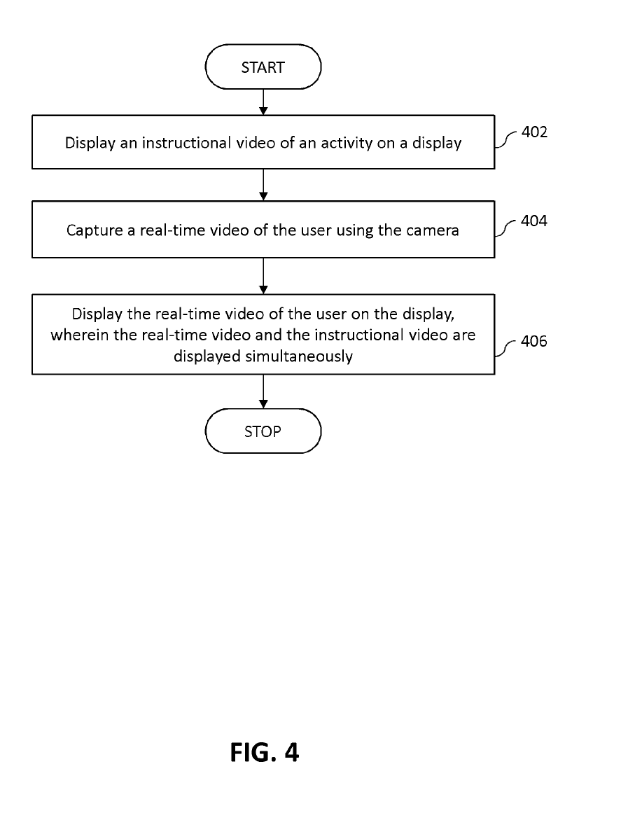

FIG. 4 illustrates a flowchart describing a method for providing real-time guidance to a user for performing an activity in accordance with an embodiment of the present invention. In an embodiment of the invention, the method for providing real-time guidance is executed by system 200.

At step 402, an instructional video of an activity is displayed on a display. On watching the instructional video, the user starts performing the activity explained in the instructional video. At step 404, the real-time video of the user, while performing the activity, is captured using a camera of the portable computing device. The camera may be a front camera or a back camera of a mobile device.

At step 406, the real-time video of the user is displayed. The real-time video and the instructional video are displayed simultaneously. The simultaneous display of the real-time video and the instructional video enable the user to perform and learn the activity.

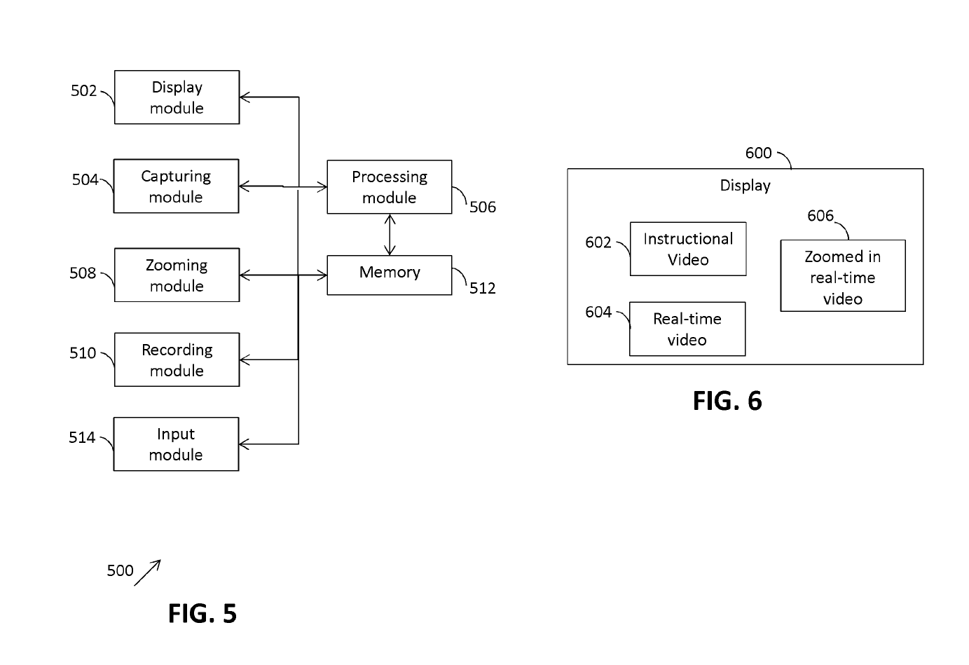

Referring now to FIG. 5, a system 500 for providing real-time guidance to a user on an activity, in accordance with another embodiment of the present invention is shown. The system 500 comprises a display module 502, a capturing module 504, a processing module 506, a zooming module 508, a recording module 510, a memory 512, and an input module 514.

Referring to FIG. 6, a block diagram of a display 600 in accordance with an embodiment of the present invention, is shown. The display 600 comprises an instructional video 602, a real-time video 604, and a zoomed-in real-time video 606.

In one embodiment, the system 500 and the display 600 are present in the portable computing device 100. In another embodiment, the system 500 is present in the portable computing device 100 and the display 600 is external to the portable computing device 100. In yet another embodiment, some modules of the system 500 may be present in a remote computing device, which is connected to the portable computing device 100, over a network, such as Internet. In various embodiments, the camera 102, the system 500 and the display 600 are interconnected and may operate in unison to provide real-time guidance to a user for performing the activity.

The display module 502 is configured to display an instructional video 602 of an activity on the display 600. The instructional video 602 comprises a set of instructions for performing the activity. The display module 502 is also configured to simultaneously display a plurality of videos on the display 600.

In one embodiment, the display module 502 is configured to simultaneously display the instructional video 602, a real-time video 604 of the user, and a zoomed version of the real-time video 606. In another embodiment, the display 600 comprises an instructional video 602 and a real-time video 604. In yet another embodiment, the display 600 comprises an instructional video 602, and a zoomed version of the real-time video 606. In yet another embodiment, the display 600 comprises an instructional video 602, a real-time video 604, a zoomed version of the real-time video 606, and another zoomed version of the real-time video (not shown). The zoomed version may illustrate a zoomed-in or zoomed-out aspect of the video.

The mutual placement of the videos 602, 604 and 606 is only illustrative, and should not be construed as limiting the scope of the invention as the videos 602, 604 and 606 can be placed on the display 600 in numerous other ways.

The capturing module 504 is configured to capture a real-time video 604 of the user using a camera 102 of the portable computing device 100. The processing module 506 is configured to process the instructional video 602, real-time video 604, and zoomed version of the real-time video 606 for their simultaneous display on the display 600.

The zooming module 508 is configured to produce at least one of zoomed-in and zoomed-out version of the real-time video 604 captured by the capturing module 504. The zoomed-in version of the real-time video 604 is displayed on the display 600 as the zoomed-in real-time video 606.

The zoomed-in real-time video 606 provides to a user a magnified version of their actions and facilitates the user to perform activities which require a close look, such as minute sculpting, dissecting a frog, applying make-up on the face, etc.

The recording module 510 is configured to record contents of the display 600. In one embodiment, the recording module 510 records only the real-time video 602. In another embodiment, the recording module 510 records a combined display of the instructional video 602 and the real-time video 604. In yet another embodiment, the recording module 510 records a combined display of the instructional video 602, the real-time video 604 and the zoomed-in real-time video 606.

The memory 512 is configured to store a plurality of videos. In one embodiment, the memory 512 is configured to store a plurality of instructional videos 602. In another embodiment, the memory 512 is configured to store contents recorded by the recording module 510.

In one embodiment, the videos recorded by the recording module 510 can be submitted to an instructor of the user for their evaluation and feedback. In another embodiment, the videos recorded by the recording module 510 can be shared on social networking sites by the user for feedback from other users.

The input module 514 is configured to receive user inputs in at least one of, but not limited to, image, text, touch, audio, haptic and video form. In a preferred embodiment, when the portable computing device 100 is a smartphone and includes a touchpad, then the user can provide their inputs using the touchpad. In one embodiment of the present invention, the user inputs are user response to the instructional video 602. In other embodiment of the present invention, the user inputs are user preferences for the instructional video 602.

In an exemplary embodiment of the present invention, the instructional video 602 may include an instructor giving instructions on how to apply mascara on eye-lashes. The real-time video 604 may be captured using a front camera and may include a user applying mascara by following the instructions described in the instructional video 602. The zoomed-in real time video 606 may display a zoomed-in image of the eye-lashes where the user wants to apply the mascara. It may be noted that the user does not need to have a minor to apply mascara on the eye-lashes. The display 600 serves both as an instruction guide as well as a mirror. The combined display of the instructional video 602, the real-time video 604 and the zoomed-in real time video 606 can be recorded and viewed later either for reinforced learning of the user or for feedback from an instructor of the user or sharing on social network sites for other users.

In a second exemplary embodiment of the present invention, the instructional video 602 may include a video on frog dissection procedure. The real-time video 604 may be captured using a back camera and may include a user performing the frog dissection by following the instructions described in the instructional video 602. The zoomed-in real time video 606 may display a zoomed-in image of the portion of the frog where the dissection needs to be done. The combined display of the instructional video 602, the real-time video 604 and the zoomed-in real time video 606 can be recorded and viewed later either for reinforced learning of the user or for feedback from an instructor of the user or sharing on social network sites for other users.

In one embodiment of the present invention, the display module 502, the capturing module 504, the processing module 506, the zooming module 508, the recording module 510, the memory 512, and the input module 514 may be implemented in a form of a hardware. In another embodiment, the modules 502-514 may be implemented in a form of a software. In another embodiment, the modules 502-514 may be implemented in a combination of hardware, software or a firmware.

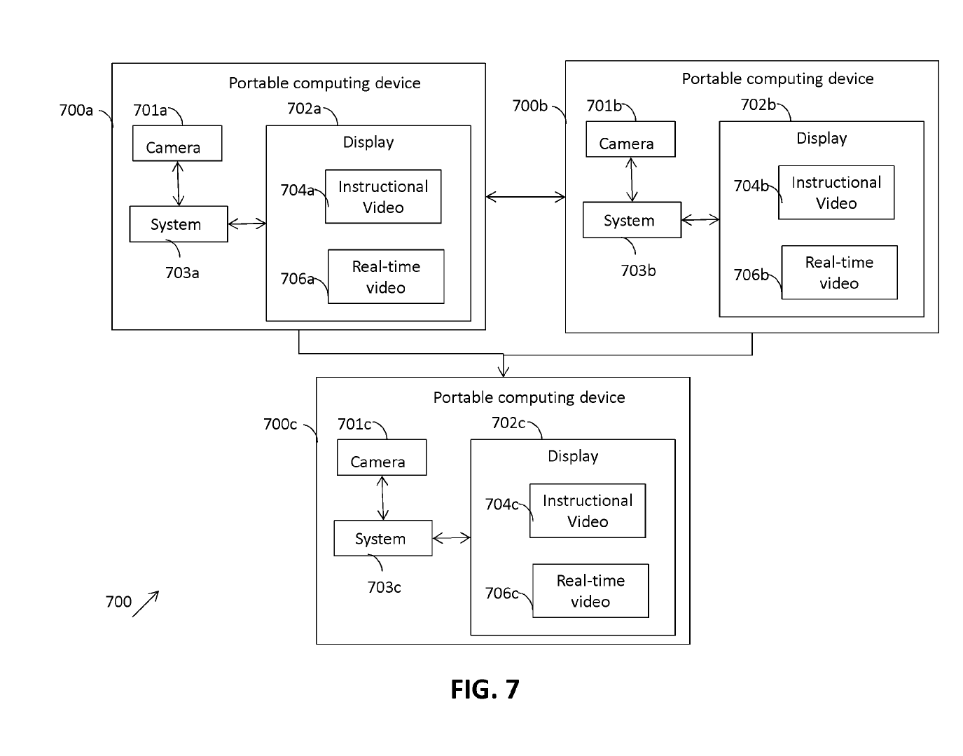

FIG. 7 is a block diagram illustrating a multi-user environment 700 for collaborative learning of an activity, in accordance with an embodiment of the present invention. The multi-user environment 700 comprises a portable computing device 700a, a portable computing device 700b, and a portable computing device 700c, each carried by a different user. In one embodiment, the portable computing devices 700a-700c may be connected over a network, such as the Internet. In another embodiment, the portable computing devices 700a-700c may not be connected to each other.

The display (702a-702c) of each portable computing device (700a-700c) comprises an instructional video (704a-704c) of an activity and a real-time video (706a-706c) of the user performing the activity according to corresponding instructional video (704a-704c). In one embodiment, the combined display of the instructional video (704a-704c) and corresponding real-time video (706a-706c) can be recorded for each user. Then the recorded videos may be shared among the users either online or offline for peer evaluation and feedback. In another embodiment, the system 703b comprises a second capturing module for capturing a real-time video 706b of a second user using a second camera 701b. The real-time video 706b of the second user may be displayed on a display 702a of a first user, along with the real-time video 706a. In this manner, the first user can watch real-time performance of the second user and provide a real-time feedback to the second user. The second user can learn from their mistakes and correctly perform the activity.

In an exemplary embodiment, the instructional video (704a-704c) of each display (702a-702c) may comprise instructions of dance steps. The real-time video (706a-706c) of each display (702a-702c) may include a user performing the dance steps. The users can then share their recorded videos among each other and with an instructor for evaluation and feedback. The users can also share the recorded videos on social networking sites for receiving feedback from other set of users.

In another exemplary embodiment, a plurality of students and a faculty, each carrying a portable computing device (700a-700c) may join a live discussion session, where the faculty and students are able to see each other using their web cameras. The faculty may discuss an instructional video with the students using a whiteboard, where both the instructional video and whiteboard are displayed on portable computing devices of each user. The entire session can be recorded and stored for reference of other students.

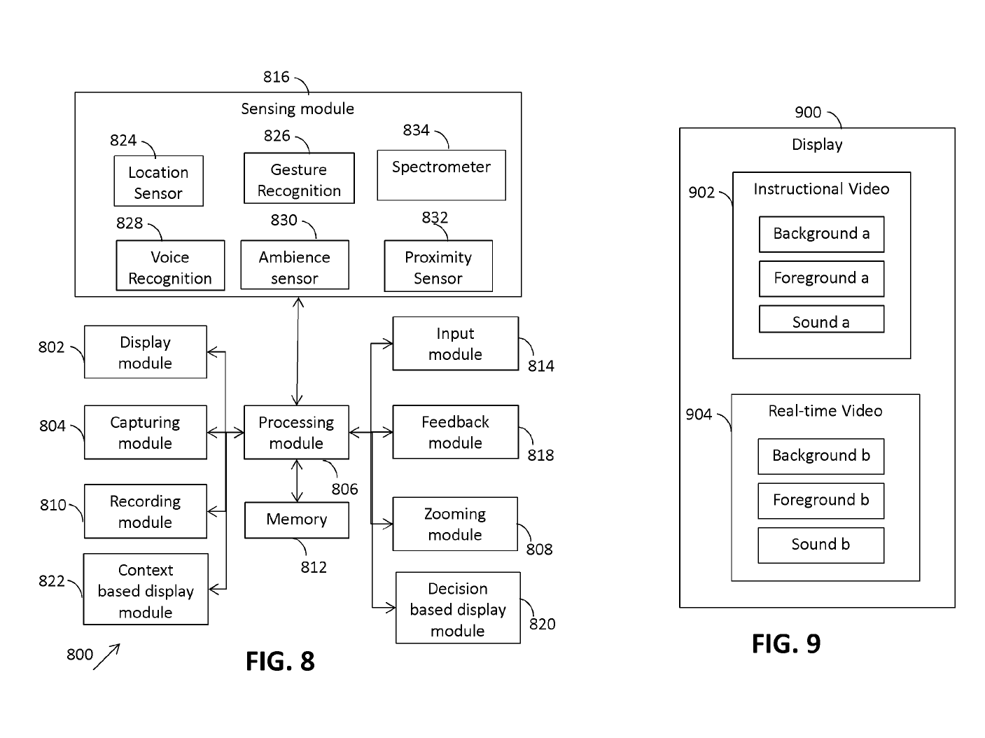

Referring to FIG. 8, a block diagram of a system 800 for providing real-time guidance to a user on an activity, in accordance with yet another embodiment of the present invention, is shown. The system 800 comprises a display module 802, a capturing module 804, a processing module 806, a zooming module 808, a recording module 810, a memory 812, an input module 814, a sensing module 816, a feedback module 818, a decision-based display module 820, and a context-based display module 822.

Referring to FIG. 9, a block diagram of a display 900 of a portable computing device 100 is shown, in accordance with an embodiment of the present invention. The display 900 comprises an instructional video 902 and the real-time video 904. The instructional video 902 comprises a set of instructions for performing an activity. The real-time video 904 comprises a user performing the activity according to the instructions described in the instructional video 902. The instructional video 902 comprises three layers, i.e. a background a, foreground a, and sound a. Similarly, the real-time video 904 comprises three layers, i.e. a background b, a foreground b, and sound b. The layers of the instructional video 902 and the real-time video 904 have been explained further in detail, in conjunction with explanation of the context-based display module 822.

In one embodiment, the system 800 and the display 900 are present in the portable computing device 100.

In another embodiment, the system 800 is present in the portable computing device 100 and the display 900 is external to the portable computing device 100.

In yet another embodiment, some modules of the system 800 may be present in a remote computing device, which is connected to the portable computing device 100, over a network, such as Internet.

In various embodiments, the camera 102, the system 800 and the display 900 are interconnected and may operate in unison to provide real-time guidance to a user for performing the activity.

The display module 802 is configured to display an instructional video 902 of an activity on the display 900. The display module 802 is also configured to simultaneously display a plurality of videos on the display 900. For example, the display module 802 simultaneously displays an instructional video 902, and a real-time video 904 of the user, performing the activity.

The capturing module 804 is configured to capture a real-time video 904 of the user using a camera 102 of the portable computing device 100. The processing module 806 is configured to process the instructional video 902 and the real-time video 904. The zooming module 808 is configured to produce at least one of zoomed-in and zoomed-out version of the real-time video 904 captured by the capturing module 804.

The recording module 810 is configured to record contents of the display 900. In one embodiment, the recording module 810 records only the real-time video 902. In another embodiment, the recording module 810 records a combined display of the instructional video 902 and the real-time video 904.

The memory 812 is configured to store a plurality of videos. In one embodiment, the memory 812 is configured to store a plurality of instructional videos 902. In another embodiment, the memory 812 is configured to store contents recorded by the recording module 810.

The input module 814 is configured to receive user inputs in at least one of, but not limited to, image, touch, text, audio, haptic and video form. In a preferred embodiment, when the portable computing device 100 is a smartphone and includes a touchpad, then the user can provide their inputs using the touchpad. In one embodiment of the present invention, the user inputs are user response to the instructional video 902. In other embodiment of the present invention, the user inputs are user preferences for the instructional video 902.

The sensing module 816 is configured to sense at least one user parameter, such as user location, environmental parameters, user activity, user input, user ambience, etc. The sensing module 816 comprises a location sensor 824, a gesture recognition module 826, a voice recognition module 828, an ambience sensor 830, a proximity sensor 832, and a spectrometer 834.

The location sensor 824 is configured to sense a current location of a user. In an embodiment of the present invention, the location sensor 824 is a GPS device of the portable computing device 100. Based on the current location, additional information such as current weather, temperature, humidity can also be determined. Other information such as user friends in the current location can also be determined using social networking applications.

The gesture recognition module 826 is configured to match gestures of a user of the real-time video 904 with gestures of an instructor of the instructional video 902 to determine whether the user actions are in synchronization with the instructor. In a preferred embodiment, the gesture recognition module 826 is useful in processing videos of activities which include large movements by hands. For example, scuba-diving gestures and the like.

In one embodiment of the present invention, the gesture recognition module 826 perform grid based pattern recognition, according to which, the real-time video 902 and the instructional video 904 are divided into equally spaced horizontal and vertical lines to form uniform grids. When the user and instructor simultaneously perform an activity, the corresponding grids show highest movement (highest deviation from previous position). The grids with highest movement are compared side by side for matching user and instructor gestures. In one embodiment of the present invention, the gesture recognition module 826 utilizes a gyroscope and an accelerometer of the portable computing device 100.

The voice recognition module 828 is configured to recognize voice of a user of the real-time video 904. In one embodiment, the voice recognition module 828 is configured to match voice of the user of the real-time video 904 with voice of the instructor of the instructional video 902. In another embodiment, the voice recognition module 828 is configured to match voice of the user of the real-time video 904 with a pre-recorded audio. The voice recognition module 828 may be an embedded feature of the portable computing device 100. In an exemplary embodiment of a student-faculty online/offline interaction, the instructional video 902 may include a faculty asking a set of questions from the student. The vocal response of the student may be compared with a pre-recorded response by the voice recognition module 828, and used for either further learning by the user, or feedback from the faculty.

The ambience sensor 830 senses the ambience of the user and changes at least one of the instruction video 902 and the real-time video 904. The proximity sensor 832 senses the proximity of the user to the portable computing device 100 and changes at least one of the instruction video 902 and the real-time video 904.

The spectrometer 834 is configured to recognize light patterns of the real-time video 904 and evaluate the electromagnetic spectrum, thus determining molecular composition. The spectrometer 834 finds applications in activities related to chemistry and physics experiments. In one embodiment, the camera 102 of the portable computing device 100 includes the spectrometer 834.

The feedback module 818 is configured to generate a real-time feedback for the user based on an output of the sensing module 816. In general, the feedback module 818 generates a feedback based on comparison between user activity and the activity specified in the instructional video 902. In one embodiment, the feedback module 818 generates a feedback when there is a mismatch between the gestures of the user of the real-time video 904 and gestures of the instructor of the instructional video 902. In another embodiment, the feedback module 818 generates a feedback when the user vocal response does not match with a pre-recorded vocal response. The feedback module 818 may provide a feedback in form of at least one of vibrational alert, text, audio, and image.

In an embodiment of the invention, the feedback module 818 provides an objective feedback that forms an input to the input module. Based on this input the decision based display module displays the next step of the instruction video, thus making the training dynamic and adaptive.

In a first exemplary embodiment, the instructional video 902 includes an instructor explaining scuba diving preparation, and the real-time video 904 includes a user practicing the activity according to the instructional video 902. The gesture recognition module 826 matches the gestures of the user of the real-time video 904 and instructor of the instructional video 902. The feedback module 818 generates a vibrational alert when there is a mismatch in the gestures.

In a second exemplary embodiment, the instructional video 902 include an instructor giving vocabulary lessons. The real-time video 904 includes a user practicing the words and sentences used by the instructor. The voice recognition module 828 converts the user's voice into text format and analyzes whether the word/sentence formation is grammatically correct. When the user makes mistakes in the words/sentence formation, the feedback module 818 generates a vibrational alert for the user.

In a third exemplary embodiment, the instructional video 902 includes an instructor demonstrating exercise of turning head on the right side and then on the left side. The real-time video 904 includes a user practicing along with the instructor. The gesture recognition module 826 records a mirror image of the user and matches gestures of the user of the real-time video 904 and instructor of the instructional video 904. The feedback module 818 may indicate either “correct” or “incorrect” after every step, on the real-time video 904 based on output of the gesture recognition module 826.

The decision-based display module 820 is configured to display an instructional video 902 on the display 900 based on user inputs and output of the sensing module 816. The sensing module 816 and the decision-based display module 820 have intelligence to recognize the user whereabouts and activity and display the instructional video 902 accordingly. For example, the decision-based display module 820 displays the instructional video based on a current location of the user and environmental factors.

In a first exemplary embodiment, when a user residing in US visits a restaurant in China, he may use his portable computing device 100 to access an instructional video on how to eat noodles. The location sensor 824 senses a current location of the user, and the decision-based display module 820 displays an instructional video 902 describing how to eat noodles with chopsticks, instead of displaying an instructional video describing how to eat noodles with forks.

In a second exemplary embodiment, a user may use their portable computing device 100 to access an instructional video for learning a procedure of framing a picture. The input module 814 receive user inputs on frame parameters, such as types of frames, sizes, color, piping, and the decision-based display module 820 displays an instructional video 902 explaining a procedure of framing the picture as per user preferences.

In a third exemplary embodiment, users in India and Thailand may use their portable computing devices 100 to access instructional video on cooking mango pan cake in the month of October. The instructional video 904 for a user in Thailand illustrates mango as an ingredient for cooking the mango pan cake. However, in India, mango is not available during October, hence the instructional video 904 displayed to the Indian user does not include mango as an ingredient, but packed mango pulp or mango essence.

In a fourth exemplary embodiment, a user may use their portable computing device 100 to access an instructional video on how to use an inhaler. When the input module 814 receives user selection as Metered Dose Inhaler, the decision-based display module 820 displays an instructional video 904 on how to use the Metered Dose inhaler. When the input module 814 receives user selection as Diskus inhaler, the decision-based display module 820 displays an instructional video 904 on how to use the Diskus inhaler.

The context-based display module 822 is configured to display a portion of the real-time video 904 based on a portion of the instructional video 902. The instructional video 902 comprises three layers, i.e. a background a, foreground a, and sound a. Similarly, the real-time video 904 comprises three layers, i.e. a background b, a foreground b, and sound b. In the instructional video 902 and the real-time video 904, the foreground is Instructor/user performing an activity, the background is the scenario or environment in which the activity is performed and sound is voice/audio of user/instructor or ambient sound.

The context-based display module 822 is configured to superimpose a background of the instructional video 902 on a background of the user video 904, so as to create a live-like environment for the user while performing his activity.

In a first exemplary embodiment, in the instructional video 902, the foreground may include an instructor providing geographical knowledge on a world map and background includes a world map. The context-based display module 822 displays the real-time video 904 of the user with a background including a world map. The user may use the background to point or display geographical information on the map.

In a second exemplary embodiment, in the instructional video 902, the foreground may include an instructor demonstrating how to talk in Spanish and the background shows the wall having elements like Spanish flag, Spanish food, and Spanish culture images. The context-based display module 822 displays the real-time video 904 of the user with a background similar to the background of the instructional video 902.

In one embodiment of the present invention, the modules 802-822 may be implemented in a form of a hardware. In another embodiment, the modules 802-822 may be implemented in a form of a software. In another embodiment, the modules 802-822 may be implemented in a combination of hardware, software or a firmware thereof.

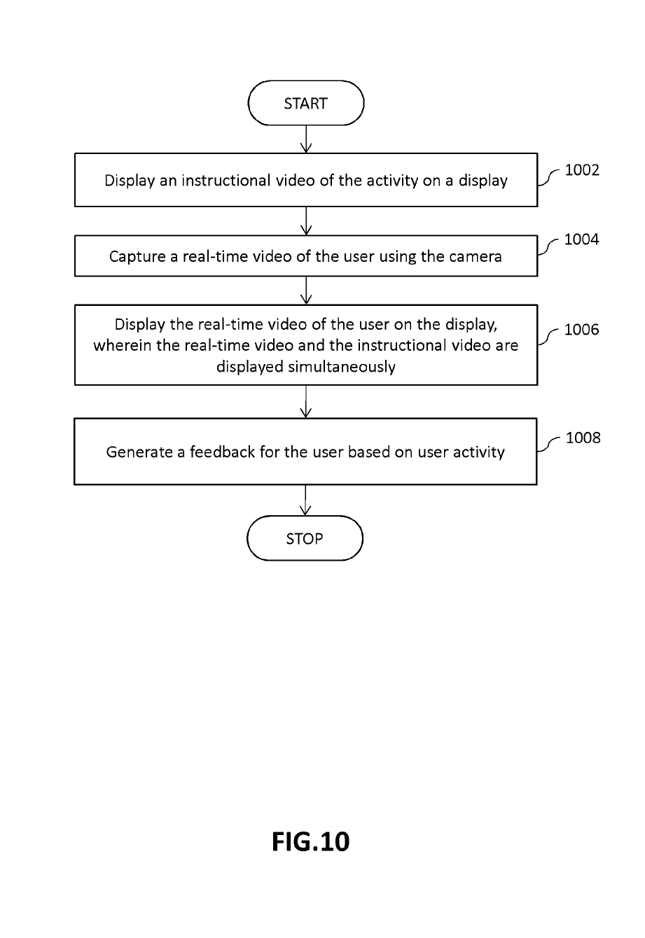

FIG. 10 illustrates a flowchart describing a method of providing real-time guidance to a user for performing an activity in accordance with another embodiment of the present invention. The method for providing the real-time guidance for performing the activity is executed by the system 800.

At step 1002, an instructional video of an activity is displayed on a display. On watching the instructional video, the user starts performing the activity explained in the instructional video. At step 1004, the real-time video of the user, while performing the activity, is captured using a camera of the portable computing device. The camera may be a front camera or a back camera of a mobile device.

At step 1006, the real-time video of the user is displayed. The real-time video and the instructional video are displayed simultaneously. The simultaneous display of the real-time video and the instructional video enable the user to perform and learn the activity.

At step 1008, a real-time feedback is generated based on user activity. The feedback is generated when there is a mismatch between user activity and the activity specified in the instructional video. The feedback is generated in form of at least one of vibrational alert, text, audio, and image.

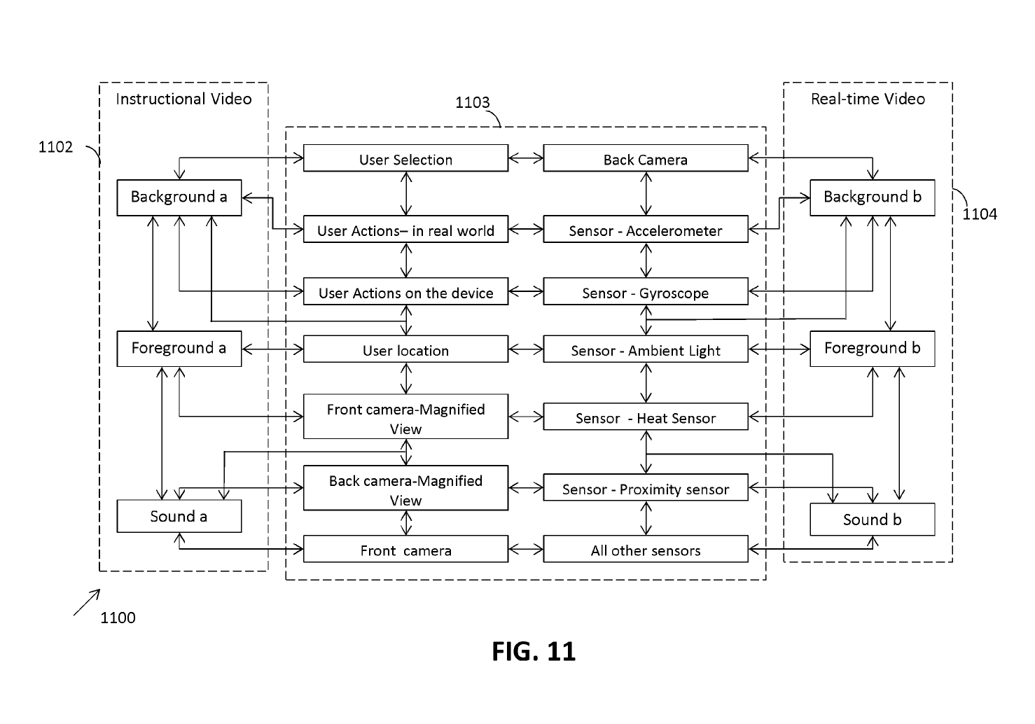

FIG. 11 illustrates a mesh network 1100 formed inside a portable computing device 100 for enabling a user to perform and learn an activity, in accordance with an embodiment of the present invention. The mesh network 1100 comprises an instructional video 1102, and the real-time video 1104 virtually connected to each other through a plurality of conditional parameters 1103.

The instructional video 1102 comprises three layers, background, foreground and sound.

Similarly, the real-time video 1104 comprises three layers, background, foreground and sound. The foreground is the instructor/user performing an activity, and background is environment of instructor/user.

The conditional parameters 1103 are different parameters and values that determine the contents of the instructional video 1102 and the real-time video 1104. The conditional parameters 1103 include, but are not limited to, sensor outputs, user inputs, user activity, environmental parameters, user requirements, etc. The layers of the instructional video 1102 and the real-time video 1104 keep on changing and adapting themselves based on the conditional parameters 1103.

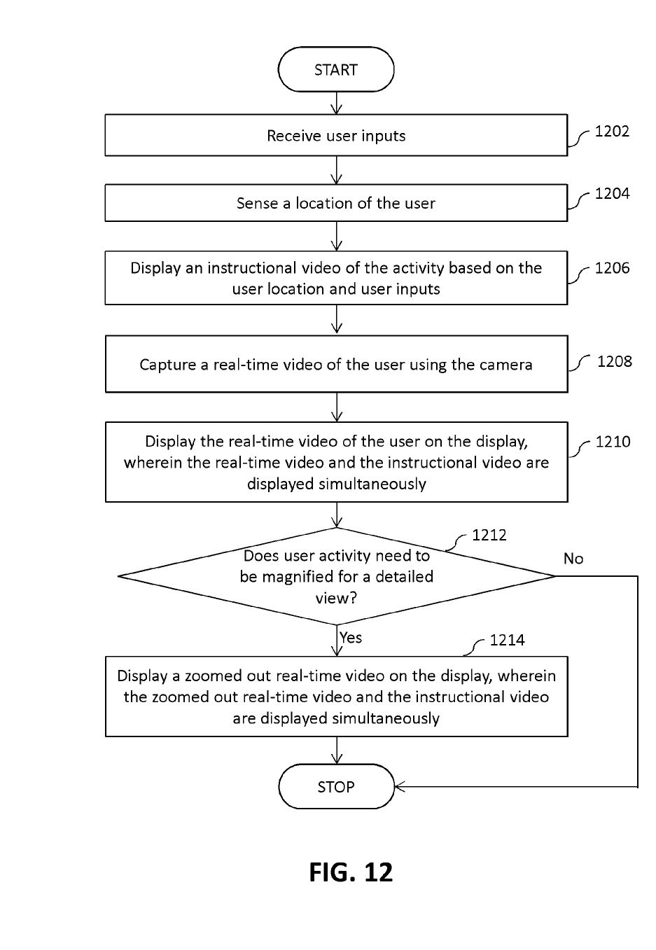

An example of performing and learning of an activity by a user, where the instructional video 1102 adapts itself to the user location and the real-time video 1104 adapts itself according to the type of instructional video 1102 has been explained with reference to FIG. 12.

FIG. 12 is a flowchart illustrating an example of a method for providing real-time guidance for enabling a user to perform and learn an activity in accordance with yet another embodiment of the present invention. The method for providing the real-time guidance is executed by the system 800. At step 1202, user inputs are received from a user for displaying an instructional video according to user requirement. At step 1204, a current location of the user is sensed. At step 1206, an instructional video of an activity is displayed on a display based on the user location and user inputs. On watching the instructional video, the user starts performing the activity explained in the instructional video.

At step 1208, the real-time video of the user, while performing the activity, is captured using a camera of the portable computing device. The camera may be a front camera or a back camera of a mobile device. At step 1210, the real-time video of the user is displayed. The real-time video and the instructional video are displayed simultaneously. At step 1212, it is checked whether user activity needs to be magnified for a detailed view. When the user activity needs to be magnified for a detailed view, then at step 1214, a zoomed-in real-time video of the user performing the activity, is displayed on the display, wherein the zoomed-in real-time video and the instructional video are displayed simultaneously. The simultaneous display of the zoomed-in real-time video and the instructional video enable the user to perform and learn the activity.

Thus, the present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claims.

What is claimed as being new and desired to be protected by Letters Patent of the United States is as follows:

1. A method of providing real-time guidance to a user for performing an activity through a portable computing device, the portable computing device comprising a camera, the method comprising the steps of:
a) displaying an instructional video of an activity on a display associated with a portable computing device, said instructional video comprising one or more instructions for performing said activity;
b) capturing a real-time video of the user using a camera associated with said portable computing device; and
c) displaying said real-time video of the user on said display, wherein said real-time video and said instructional video are displayed simultaneously on said display, the simultaneous display of said real-time video and said instructional video enable the user to perform said activity.

2. The method as claimed in claim 1 further comprising the step of capturing a second real-time video of a second user using a second camera.

3. The method as claimed in claim 2, wherein said instructional video, said real-time video and said second real-time video are displayed simultaneously on said display.

4. The method as claimed in claim 1, wherein said instructional video comprises at least one of text, audio, video and image.

5. The method as claimed in claim 1 further comprising the step of displaying at least one of a zoomed-in version, and a zoomed-out version of said real-time video on said display.

6. The method as claimed in claim 1 further comprising the steps of:
recording a combined display of said real-time video and said instructional video to produce a recorded content; and
displaying said recorded content to one or more users.

7. The method as claimed in claim 1 further comprising the step of combining a portion of said real-time video and a portion of said instructional video on said display.

8. The method as claimed in claim 1 further comprising the step of sensing a location of the user.

9. A system for providing real-time guidance to a user for performing an activity through a portable computing device, the portable computing device comprising a camera, said system comprising:
a portable computing device having a processor, at least one camera, and at least one display;
a capturing module associated with said processor, said capturing module being configured to capture a real-time video of a user;
a processing module associated with said processor, said processing module being configured to process an instructional video, said instructional video comprising one or more instructions for performing an activity; and
a display module associated with said processor, said display module being configure to display said real-time video and said instructional video on said display, wherein said real-time video and said instructional video are being displayed simultaneously on said display, said simultaneous display of said real-time video and said instructional video enable the user to perform said activity.

10. The system as claimed in claim 9, wherein said portable computing device further comprising a memory to store said instructional video.

11. The system as claimed in claim 9 further comprising a second capturing module configured to capture a second real-time video of a second user.

12. The system as claimed in claim 9, wherein said display module is further configured to simultaneously display said instructional video, said real-time video and said second real-time video.

13. The system as claimed in claim 9 further comprising a zooming module associated with said processor, said zooming module being configured to produce at least one of a zoomed in version and a zoomed out version of said real-time video.

14. The system as claimed in claim 9 further comprising a recording module associated with said processor, said recording module being configured to record a combined display of said real-time video and said instructional video to produce a recorded content, and wherein said display module is configured to display said recorded content to one or more another users.

15. The system as claimed in claim 9 further comprising a remote computing device for streaming said instructional video to said processing module.

16. The system as claimed in claim 9, wherein said processing module is configured to combine a portion of said real-time video and a portion of said instructional video on said display.

17. The system as claimed in claim 9 further comprising a location sensing module for sensing a location of the user.

18. A computer program product stored on a non-transitory computer-readable medium and comprising instructions for execution by a processor, such that the instructions when executed provide real-time guidance to a user for performing an activity through a portable computing device, said instructions comprising:
computer usable program code for displaying an instructional video of an activity on a display of a portable computing device, said instructional video comprising one or more instructions for performing an activity;
computer usable program code for capturing a real-time video of a user using a camera of said portable computing device; and
computer usable program code for displaying said real-time video of the user on said display, wherein said real-time video and said instructional video are displayed simultaneously on said display, said simultaneous display of said real-time video and said instructional video enable the user to perform said activity.

19. The computer program product as claimed in claim 18 further comprising instructions for capturing a second real-time video of a second user using a second camera, wherein said instructional video, said real-time video and said second real-time video are displayed simultaneously on said display.

20. The computer program product as claimed in claim 20 further comprising instructions of:
computer usable program code for displaying at least one of a zoomed-in version and zoomed-out version of said real-time video on said display;
computer usable program code for recording combined display of said real-time video and said instructional video to produce a recorded content;
computer usable program code for displaying said recorded content to one or more users;
computer usable program code for combining a portion of said real-time video and a portion of said instructional video on said display; and
computer usable program code for sensing a location of the user.
